(19) United States
(12) Patent Application Publication
(10) Pub. No.: US 2012/0286849 A1
(43) Pub. Date: Nov. 15, 2012

(54) SEMICONDUCTOR DEVICE AND SEMICONDUCTOR PACKAGE SYSTEM

(75) Inventors: Tae Yong LEE, Icheon-si (KR); Sang Hoon SHIN, Icheon-si (KR)

(73) Assignee: SK hynix Inc., Icheon-si (KR)

(21) Appl. No.: 13/468,466

(22) Filed: May 10, 2012

(30) Foreign Application Priority Data
May 12, 2011 (KR) 10-2011-0044633

(51) Int. Cl. H01H 37/76

(52) U.S. Cl. 327/525

(57) ABSTRACT

A semiconductor apparatus includes: a plurality of electrical fuses; a rupture unit configured to rupture an electrical fuse in response to rupture information applicable to the plurality of electrical fuses, when a rupture enable signal is activated; a scan unit configured to output information on whether an each of the plurality of electrical fuses are ruptured or not, as scan information, when a scan enable signal is activated; and a shift register unit configured to receive an input signal in synchronization with a clock signal and store the input signal as the rupture information, and configured to receive the scan information and output the scan information as an output signal in synchronization with the clock signal.

### CROSS-REFERENCES TO RELATED APPLICATION

The present application claims priority under 35 U.S.C. §119(a) to Korean application number 10-2011-0044633, filed on May 12, 2011, in the Korean Intellectual Property Office, which is incorporated herein by reference in its entirety as if set forth in full.

### BACKGROUND

1. Technical Field

Various embodiments of the present disclosure relate to semiconductor devices and semiconductor package systems, and more particularly, to semiconductor devices and semiconductor is package systems that include electrical fuses.

2. Related Art

Recently, both the capacity and speed of semiconductor memory, which is used as a memory device in most electronic systems, have rapidly increased. Furthermore, various attempts have been made to mount a memory with a larger capacity in a smaller area and effectively drive the memory.

In order to improve the integration degree of a semiconductor memory, a 3-dimensional packaging technology for stacking a plurality of memory chips has been recently applied as an improvement to prior 2-dimensional arrangement technology. The 3D packaging technology may be used to increase capacity and improve integration by reducing the overall size or footprint of the semiconductor package.

Such 3D packaging technology may include a system-in-package (SIP) method, a package-on-package (POP) method, a through-silicon via (TSV) method and the like.

The TSV method is considered as an alternative for overcoming transmission speed degradation depending on the distance from a control chip on a module, vulnerability of a data bandwidth, and transmission speed degradation which occurs as a result of variables on the semiconductor package. The TSV method forms paths passing through a plurality of memory chips and forms electrodes in the paths to perform a communication between the respective memory chips and a control chip. Between the paths passing through the plurality of memory chips, bumps are formed to electrically couple the respective memory chips or the control chip.

Typically, one or more memory cells on a semiconductor device may fail during the fabrication process. Accordingly, repair methods are used to repair the failed cells. In semiconductor memory packages that utilize 2D arrangement technology, metal fuses may be used to permit repair of failed cells. When a failed cell occurs, the semiconductor memory apparatus may be repaired by cutting the metal fuse using a laser.

However, in the stacked memory chip arrangement that is typical of 3D packaging technology, such as the TSV packaging method, such metal fuses are not practical since they cannot usually be accessed once the memory chips are stacked.

Accordingly, electrical fuses are typically used in semiconductor packages that employ 3D packaging technology. These electrical fuses are typically formed with a high-resistance element, and employ a rupture method in which an insulation layer of the high-resistance element is destroyed by applying an overvoltage to thereby reduce a resistance value.

In 3D packaging processes, production of semiconductor memory packages may involve three repair steps, each of which provide for the repair of failed cells.

According to a first repair step, a failed cell is checked when the semiconductor memory device is in a single wafer state, typically by sensing through a probe test. Repair of failed cells may occur by cutting a metal fuse using a laser. Since the metal fuse of the semiconductor memory device in a wafer state is exposed to the outside, access to the fuses by a laser cutter is possible.

In 3D packaging processes, the memory chip wafers and other memory chip wafers are then typically stacked and electrically coupled to each other (memory stack state).

While the memory chips in a wafer state are stacked, a high-temperature and high-pressure heat treatment is performed. During these processes, further failure of cells and/or TSV's may occur.

As described above, when a semiconductor memory device is in the memory stack state, access to the metal fuses may not be permitted. Therefore, failed cell repair in the memory stack state using a laser cutter is not possible.

Therefore, in a second repair step, the stacked memory is checked for failed cells and repair occurs by rupturing an electrical fuse associated with each failed cell.

Following this step, the semiconductor memory apparatus in the memory stack state is typically combined with a control chip for controlling the memory stack, and a package board, which are stacked and electrically coupled to each other (semiconductor package state).

While the semiconductor memory apparatus in the memory stack state, the control chip, and the package board are stacked, a high-temperature and high-pressure heat treatment is also performed. Again, during these processes, further failure of cells and/or TSV's may occur.

Thus, a third repair step is performed in which the failed cell is checked when the semiconductor memory apparatus is in the semiconductor package state. Repair occurs by rupturing an electrical fuse associated with each failed cell.

Semiconductor memory devices may be sold in a memory stack state as well as in a semiconductor package state.

When a semiconductor memory device is sold in a memory stack state, a semiconductor package manufacturer may further package the semiconductor memory device by combining the semiconductor memory apparatus in a memory stack state with a control chip, and a package board. The control chip and the package board are typically prepared by the semiconductor package manufacturer.

As described above, the manufacturer of a memory stack may implement a circuit on the control chip which repairs the semiconductor memory stack by performing a specific test mode. In such cases, the memory stack manufacturer would need to provide the semiconductor package manufacturer with a test mode code or other information for repairing additional failed cells during a subsequent package process. However, disclosure of such information to the outside may be undesirable for the memory stack manufacturer. Accordingly, it would be desirable to provide semiconductor devices and semiconductor packaging systems that permit rupture of electrical fuses without the need for providing a test mode code to outside semiconductor package manufacturers.

### SUMMARY

Various aspects of the present invention include a semiconductor device including electrical fuses which may be ruptured without the need for a separate test mode, and a semiconductor package system having the same.

In one embodiment of the present invention, a semiconductor apparatus includes: a plurality of electrical fuses; a rupture unit configured to rupture an electrical fuse in response to rupture information applicable to the plurality of electrical fuses, when a rupture enable signal is activated; a scan unit configured to output information on whether an each of the plurality of electrical fuses are ruptured or not, as scan information, when a scan enable signal is activated; and a shift register unit configured to receive an input signal in synchronization with a clock signal and store the input signal as the rupture information, and configured to receive the scan information and output the scan information as an output signal in synchronization with the clock signal.

In another embodiment of the present invention, a semiconductor package system includes: a semiconductor chip including a plurality of electrical fuses; and a control chip configured to control the semiconductor chip. The control chip includes a joint test action group (JTAG) circuit for controlling the plurality of electrical fuses.

### BRIEF DESCRIPTION OF THE DRAWINGS

The accompanying drawings, which are incorporated in and constitute a part of this specification, illustrate various features, aspects, and embodiments consistent with the invention and, together with the description, serve to explain the principles of the invention.

FIG. 1 is a schematic block diagram illustrating a semiconductor apparatus and a semiconductor package system having the same according to one embodiment of the present invention;

FIG. 2 is a block diagram of the semiconductor apparatus of FIG. 1;

FIG. 3 is a block diagram of a semiconductor apparatus according to another embodiment of the present invention; and

FIG. 4 is a diagram illustrating a semiconductor package system in which the semiconductor apparatuses according to the embodiment of the present invention are stacked by using the TSV method.

### DETAILED DESCRIPTION

Hereinafter, a semiconductor apparatus and a semiconductor package system having the same according to the present invention will be described below with reference to the accompanying drawings through exemplary embodiments. Advantages and characteristics of the present invention will be apparent from the description that follows. The present invention is not limited to the exemplary embodiments described below but may be implemented in various forms. The exemplary embodiments are provided to enable those skilled in the art to thoroughly understand the teachings of the present invention.

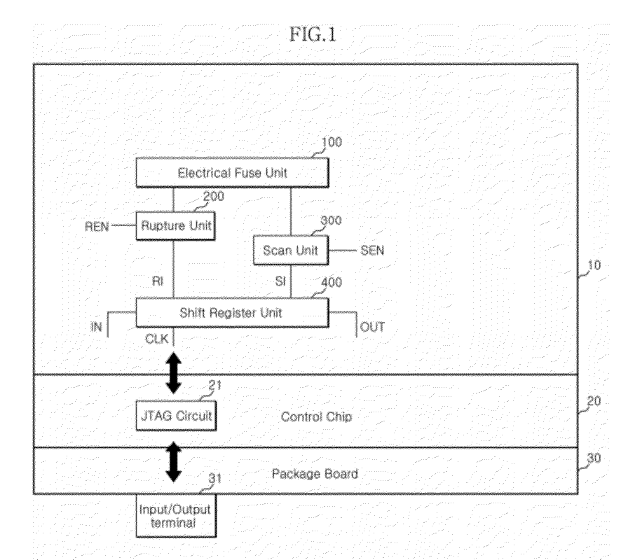

Referring to FIG. 1, a semiconductor apparatus 10 according to one embodiment of the present invention may include an electrical fuse unit 100, a rupture unit 200, a scan unit 300, and a shift register unit 400.

The electrical fuse unit 100 includes a plurality of electric fuses.

The rupture unit 200 is configured to rupture at least one of the electrical fuses according to rupture information RI, applicable to the plurality of electric fuses, when a rupture enable signal REN is activated.

The scan unit 300 is configured to output information on whether the plurality of electrical fuses are ruptured or not, as scan information SI, when a scan enable signal SEN is activated.

The shift register unit 400 is configured to receive an input signal IN in synchronization with a clock signal CLK and store the received input signal IN as the rupture information RI.

Furthermore, the shift register unit 400 is configured to receive the scan information SI and output the scan information SI as an output signal OUT in synchronization with the clock signal CLK.

FIG. 1 illustrates that the semiconductor apparatus 10 includes the electrical fuse unit 100, the rupture unit 200, the scan unit 300, and the shift register unit 400.

In the example of FIG. 1, the semiconductor apparatus 10 is configured to perform both a rupture function for the electrical fuse unit 100 and a function of determining whether the electrical fuses are ruptured or not, that is, a scan function.

As another example, the semiconductor apparatus 10 may include only the electrical fuse unit 100, the rupture unit 200, and the shift register unit 400, in order to perform only the rupture function.

Furthermore, the semiconductor apparatus 10 may include only the electrical fuse unit 100, the scan unit 300, and the shift register unit 400, in order to perform only the scan function.

A semiconductor package system may be configured by adding a control chip 20 to the semiconductor apparatus 10.

The control chip 20 is a semiconductor apparatus for controlling the semiconductor apparatus 10, and may include a general control chip.

The control chip 20 may include a joint test action group (JTAG) circuit 21 for controlling the plurality of electrical fuses.

In general, a control chip of a semiconductor package system includes a JTAG circuit for testing whether the semiconductor package system operates normally or not. Therefore, the JTAG circuit 21 for controlling the plurality of electrical fuses may be used by sharing a JTAG circuit provided in a general control chip.

Furthermore, the semiconductor package system may further include a package board 30.

The package board 30 is a board having an input/output terminal for controlling the semiconductor package system, and includes an input/output terminal 31 for the JTAG circuit 21.

When the JTAG circuit 21 for controlling the plurality of electrical fuses is used by sharing a JTAG circuit provided in a general control chip, the input/output terminal 31 may be configured to share the input/output terminal of the JTAG circuit.

The input/output terminal 31 includes test data in (TDI), test data out (TDO), test mode select (TMS), test clock (TCK), and test reset (TRST) terminals.

The TDI, TDO, TMS, TCK, and TRST terminals are input/output terminals used in a general JTAG circuit.

One or more of the input signal IN, the clock signal CLK, the rupture enable signal REN, and the scan enable signal SEN may be controlled by the JTAG circuit 21.

Accordingly, a repair operation of the semiconductor package system illustrated in FIG. 1, for example, a rupture operation and a scan operation may be controlled through the input/output terminal 31.

More specifically, a user of the semiconductor package system may control the JTAG circuit 21 through the input/output terminal 31.

Furthermore, the user of the semiconductor package system may control the input signal IN, the clock signal CLK, the rupture enable signal REN, and the scan enable signal SEN through the JTAG circuit 21.

Furthermore, the user of the semiconductor package system may control the electrical fuse unit 100, the rupture unit 200, the scan unit 300, and the shift register unit 400 by controlling the input signal IN, the clock signal CLK, the rupture enable signal REN, and the scan enable signal SEN.

Accordingly, the user of the semiconductor package system may control a repair operation of the semiconductor apparatus 10 through the input/output terminal 31.

As will be recognized from the foregoing, semiconductor package systems according to an embodiment of the present invention do not need to enter a separate test mode in order for the semiconductor apparatus 10 to perform a repair operation.

For example, when a memory stack manufacturer implements a circuit which may repair a semiconductor memory apparatus by performing a specific test mode, due to the advantages provided by the invention, the memory stack manufacturer does not need to provide the semiconductor package manufacturer with a test mode code for repairing failed cells which may occur during a subsequent package process. In this case, since the memory stack maker does not need to open the test mode implementation technology, such as repair control technology to the outside, which alleviates security concerns.

More specifically, the semiconductor apparatus 10 of the semiconductor package system according to the embodiment of the present invention ruptures and scans the plurality of electrical fuses in response to the input signal IN, the scan enable signal SEN the rupture enable signal REN, and the clock signal CLK, which are inputted from the control chip 20. The semiconductor apparatus according to the embodiment of the present invention therefore does not need to provide a separate test mode code to a semiconductor package maker.

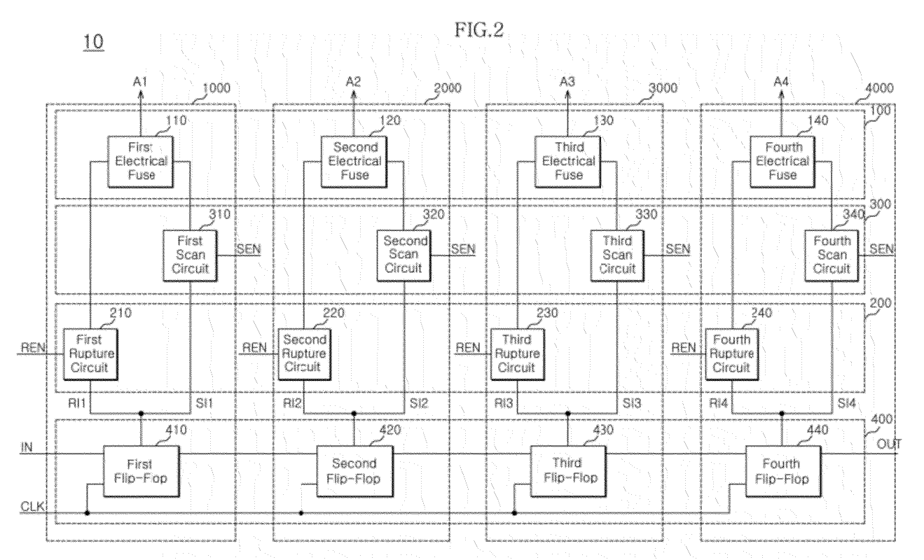

FIG. 2 illustrates an exemplary embodiment of semiconductor apparatus 10 having an electrical fuse unit 100, which includes four electrical fuses 110 to 140. It will be recognized, however, that the present invention is not limited thereto.

The rupture unit 200 illustrated in FIG. 2 includes four rupture circuits 210 to 240 corresponding to the four electrical fuses 110 to 140.

The scan unit 300 illustrated in FIG. 2 includes four scan circuits 310 to 340 corresponding to the four electrical fuses 110 to 140.

The shift register unit 400 illustrated in FIG. 2 includes four flip-flops 410 to 440 corresponding to the four electrical fuses 100 to 140.

The semiconductor apparatus 10 illustrated in FIG. 2 is configured to perform a rupture operation for the four electrical fuses 110 to 140 and a scan operation of determining whether the electrical fuses are ruptured or not.

The rupture operation of the semiconductor apparatus 10 illustrated in FIG. 2 will be described as follows.

The input signal IN is serially inputted to the first flip-flop 410.

The input signal IN is a signal for determining whether or not to rupture the first to fourth electrical fuses 110 to 140.

For example, an input signal IN consisting of four bits of <1010> may be serially inputted to rupture only the first and third electrical fuses 110 and 130.

The input signal IN may be generated by the JTAG circuit 21 provided in the control chip 200.

Each of the first to fourth flip-flops 410 to 440 is configured to receive the input signal in synchronization with the clock signal CLK and apply the received signal in connection with the next flop-flop.

The clock signal CLK may be generated by the JTAG 21 provided in the control chip 200.

For example, each of the first to fourth flip-flops 410 to 440 applies the input signal IN by one bit in connection with the next flip-flop, in response to a rising edge of the clock signal CLK. Therefore, when the clock signal CLK toggles four times, the first to fourth flip-flops 410 to 440 latch <1>, <0>, <1>, and <0> as the rupture information RI1 to RI4, respectively.

Then, the rupture enable signal REN is applied to the first to fourth rupture circuits 210 to 240.

The rupture enable signal REN may be generated by the JTAG circuit 21 provided in the control chip 200.

The first to fourth rupture circuits 210 to 240 are configured to rupture electrical fuses where the rupture information RI1 to RI4 corresponds to <1>, that is, the first and third electrical fuses 110 and 130, in response to the rupture enable signal REN.

The first to fourth rupture circuits 210 to 240 may include a general rupture circuit for rupturing an electrical fuse.

For example, an overvoltage may be applied to the first and third electrical fuses 110 and 130, and insulation layers thereof may be destroyed to change the resistance values of the first and second electrical fuses 110 and 130 from high resistance to low resistance.

For example, as a result of the destruction of the insulation layers and the corresponding low resistance for specific fuses, the first to fourth electrical fuses 110 to 140 will have resulting fixed resistance values, which represents information A1 to A4 of <1010> according to the result.

The fixed information A1 to A4 may be utilized in a variety of ways having an effect upon the operation of the semiconductor apparatus 10. For example, the fixed information A1 to A4 may include a redundancy address for replacing a failed cell. Alternatively, the fixed information A1 to A4 may include a redundancy address for replacing a failed TSV. Alternatively, the fixed information A1 to A4 may include a control signal for controlling a predetermined driver.

The fixed information A1 to A4 of the electrical fuses 110 to 140 does not need to be limited to a specific use range to which the present invention may be applied.

The scan operation of the semiconductor apparatus 10 illustrated in FIG. 2 will be described as follows.

The scan enable signal SEN is inputted to the first to fourth scan circuits 310 to 340.

The scan enable signal SEN may be generated by the JTAG circuit 21 provided in the control chip 200.

The first to fourth scan circuits 310 to 340 scan whether the first to fourth electrical fuses 110 to 140 are ruptured or not, in response to the scan enable signal SEN, and store the scan result as the scan information SI1 to SI4.

The first to fourth scan circuits 310 to 340 may include a general scan circuit for determining whether an electrical fuse is ruptured or not.

For example, the first to fourth scan circuits 310 to 340 may check that the resistance values of the first and third electrical fuses 110 and 130 among the first to fourth electrical fuses 110 to 140 are low resistance values, and output the scan information SI1 to SI4 as <1>, <0>, <1>, and <0>, respectively.

The scan information SI1 to SI4 is applied to latches of the first to fourth flip-flops 410 to 440 of the shift register 400.

Accordingly, the first to fourth flop-flops 410 to 440 latch <1>, <0>, <1>, and <0>, respectively.

The first to fourth flip-flops 410 to 440 output the scan information SI1 to SI4 as the output signal OUT in connection with the next flip-flop, in synchronization with the clock signal CLK.

For example, the first to fourth flip-flops 410 to 440 apply the scan information SI1 to SI4, that is, the latch values by one bit in connection with the next flip-flop, in response to rising edges of the clock signal CLK. Therefore, when the clock signal CLK toggles four times, the first to fourth flip-flops 410 to 440 serially output <1>, <0>, <1>, and <0>, respectively, as the output signal OUT.

The output signal OUT may be inputted to the JTAG circuit 21.

The JTAG circuit 21 may be configured to store the output signal OUT in an internal register and then output the stored signal to an external device outside the package board 30 through the input/output terminal 31.

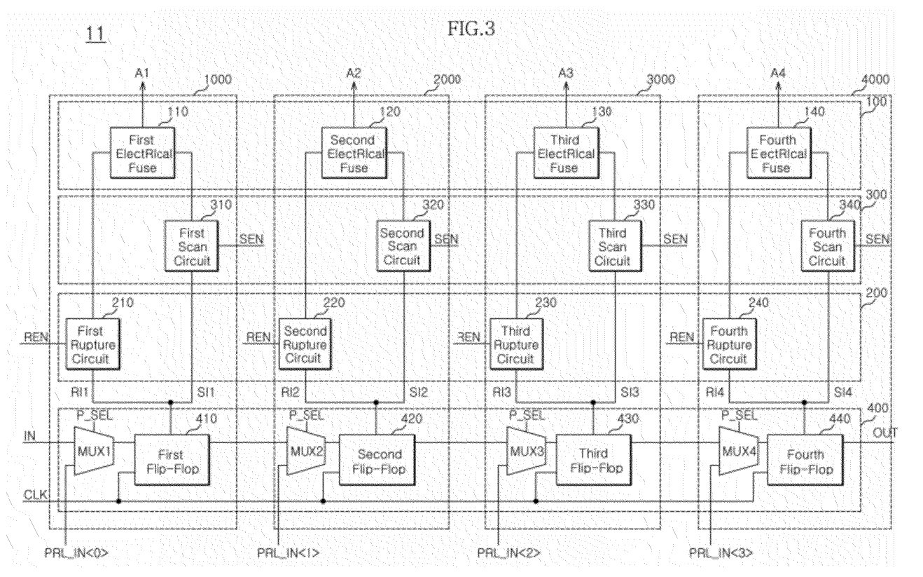

A semiconductor apparatus 11 illustrated in FIG. 3 may be configured in substantially the same manner as the semiconductor apparatus 10 in FIG. 2, except for the addition of the first to fourth multiplexers MUX1 to MUX4. Therefore, the configuration and operation of the semiconductor apparatus 11 is similar to that of the semiconductor apparatus 10 in FIG. 2, except for the operations associated with the first to four multiplexers MUX1 to MUX4.

Therefore, the descriptions of the semiconductor apparatus 11 of FIG. 3 will be focused on the configuration and operation of the first to fourth multiplexers MUX1 to MUX4.

The semiconductor apparatus 11 of FIG. 3 may receive a serial input signal IN or parallel input signals PRL_IN<0> to <3> through the JTAG circuit 21. That is, when a parallel select signal P_SEL is activated, the first to fourth multiplexers MUX1 to MUX4 simultaneously receive the parallel input signals PRL_IN<0> to <3>, and then provide the received signals to the first to fourth flip-flops 410 to 440, respectively.

Meanwhile, when the parallel select signal P_SEL is deactivated, the first to fourth multiplexers MUX1 to MUX4 receive the serial input signal IN and sequentially shift the received signal through the first to fourth flip-flops 410 to 440.

The semiconductor apparatus 11 of FIG. 3 may receive the serial input signal IN or the parallel input signals PRL_IN<0> to <3> through the JTAG circuit 21 according to the select signal P_SEL, and use the received signals as the rupture information RI1 to RI4.

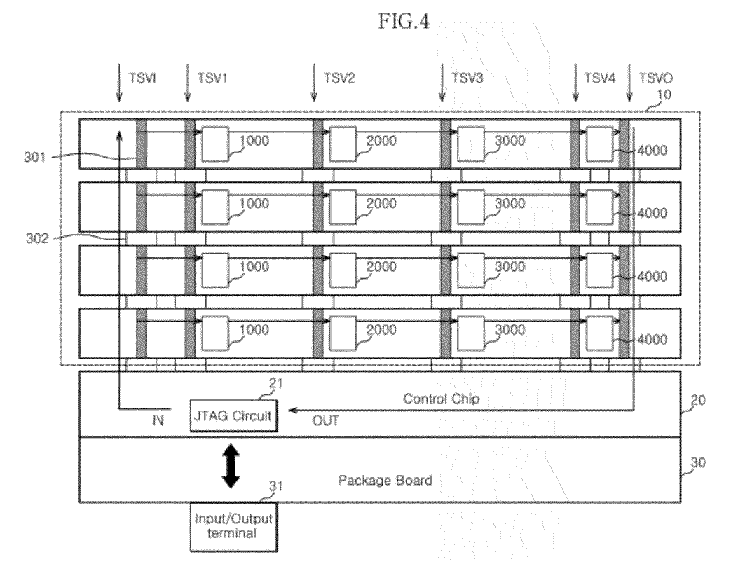

FIG. 4 illustrates that a semiconductor package system includes the semiconductor apparatus 10 having four chips stacked therein with TSVs 301. Furthermore, each of the chips include bumps 302 for coupling the respective TSVs.

Referring to FIG. 4, each of the chips include a TSV for receiving the input signal IN, a TSV for outputting the output signal OUT, and four additional TSVs. For convenience of descriptions, they are referred to as an input TSV TSVI, an output TSV TSVO, and first to fourth TSVs TSV1 to TSV4, respectively. The first to fourth TSVs TSV1 to TSV4 include repair circuits 1000 to 4000 for repairing a fail, respectively.

The repair circuits 1000 to 4000 may include one or more electrical fuses, one or more rupture circuits, one or more scan circuits, and/or one or more flip-flops, as illustrated in FIG. 2 or 3. For example, the repair circuit 2000 may include the second electrical fuse 120, the second rupture circuit 220, the second can circuit 320, and the second flip-flop 420.

The respective flip-flops of the repair circuits 1000 to 4000 may be configured as a shift register type, as illustrated in FIG. 2 or 3.

The four chips illustrated in FIG. 4 may operate according to the same principles as the semiconductor apparatus 10 illustrated in FIG. 2.

In the semiconductor package system illustrated in FIG. 4, the input signal IN is outputted from the JTAG circuit 2, and then provided to the first flip-flop 410 of the first repair circuit 1000 through the input TSV TSV1.

In the semiconductor package system illustrated in FIG. 4, the output signal OUT is outputted from the fourth flip-flop 440 of the fourth repair circuit 4000, and then provided to the JTAG circuit 21 through the output TSV TSVO.

The first to fourth repair circuits 1000 to 4000 receive the rupture enable signal REN, the scan enable signal SEN, and the clock signal CLK (not illustrated), similar to the semiconductor apparatus illustrated in FIG. 2 or 3.

The rupture enable signal REN, the scan enable signal SEN, and the clock signal CLK may be generated from the JTAG circuit 21, and provided to the first to fourth repair circuits 1000 to 4000 through a TSV (not illustrated) such as the input TSV TSVI.

Furthermore, a chip select signal (not illustrated) may be used to select a specific chip among the four chips. The chip select signal may be generated from the control chip 20, and then provided to the four chips through a TSV (not illustrated) such as the input TSV TSVI.

The semiconductor package system illustrated in FIG. 4 may perform various operations as well as the above-described rupture and scan operations, depending on the design.

For example, the semiconductor package system illustrated in FIG. 4 may be configured to determine whether the TSVs included therein are acting normally or not, and then output this determined result to, for example, an outside source.

More specifically, the first to fourth TSVs TSV1 to TSV4 include the flip-flop circuits 410 to 440 corresponding to the respective TSVs.

Furthermore, the flip-flops 410 to 440 may output values latched therein as the output signal OUT. When the respective TSVs include the flip-flop circuits, it means that any information related to the respective TSVs may be stored.

Therefore, when the semiconductor package system illustrated in FIG. 4 additionally includes a circuit capable of sensing resistance values of the respective TSVs or current values passed through the respective TSVs and is configured to store the sensing result in the flip-flop circuits, the semiconductor package system may determine whether the TSVs are acting normally or not, and then output this determined result to, for example, an outside source.

The information stored in the flip-flop circuits may include other information related to the TSVs as well as the information on whether the TSVs are acting normally or not.

While certain embodiments have been described above, it will be understood to those skilled in the art that the embodiments described are by way of example only. Accordingly, the semiconductor apparatus described herein should not be limited based on the described embodiments. Rather, the semiconductor apparatus described herein should only be limited in light of the claims that follow when taken in conjunction with the above description and accompanying drawings.

What is claimed is:

1. A semiconductor apparatus comprising:
a plurality of electrical fuses;
a rupture unit configured to rupture an electrical fuse in response to rupture information applicable to the plurality of electrical fuses, when a rupture enable signal is activated;
a scan unit configured to output information on whether an each of the plurality of electrical fuses are ruptured or not, as scan information, when a scan enable signal is activated; and
a shift register unit configured to receive an input signal in synchronization with a clock signal and store the input signal as the rupture information, and configured to receive the scan information and output the scan information as an output signal in synchronization with the clock signal.

2. The semiconductor apparatus according to claim 1, wherein the shift register unit comprises a plurality of flip-flops coupled in series and the shift register unit configured to receive the input signal or the scan information.

3. The semiconductor apparatus according to claim 1, wherein, in response to the clock signal, the shift register unit receives the input signal in series, then generates the rupture information and outputs the rupture information in parallel.

4. The semiconductor apparatus according to claim 1, wherein the shift register unit receives the scan information in parallel, and in response to the clock signal, the shift register unit serially outputs the scan information through the output signal.

5. The semiconductor apparatus according to claim 2, wherein a flip-flop is allocated to a respective electrical fuse capable of receiving information on the respective electrical fuse.

6. The semiconductor apparatus according to claim 1, further comprising a plurality of memory cells,
wherein at least one of the electrical fuses comprises an electrical fuse for repairing a memory cell.

7. The semiconductor apparatus according to claim 1, wherein the semiconductor apparatus comprises a multi-chip semiconductor apparatus in which a plurality of chips are stacked and coupled through a plurality of TSVs, and
at least one of the electrical fuses comprises electrical fuses for repairing a TSV.

8. The semiconductor apparatus according to claim 1, wherein one or more of the rupture enable signal, the scan enable signal, and the input signal are received from a source external to the semiconductor apparatus.

9. The semiconductor apparatus according to claim 1, wherein the output signal is transmitted outside the semiconductor apparatus.

10. A semiconductor package system comprising:
a semiconductor chip comprising a plurality of electrical fuses; and
a control chip configured to control the semiconductor chip,
wherein the control chip comprises a joint test action group (JTAG) circuit for controlling the plurality of electrical fuses.

11. The semiconductor package system according to claim 10, wherein the semiconductor chip comprises:
a shift register unit configured to receive an input signal in synchronization with a clock signal and store the received signal as rupture information; and
a rupture unit configured to rupture an electrical fuse corresponding to the rupture information among the plurality of electrical fuses when a rupture enable signal is activated.

12. The semiconductor package system according to claim 11, wherein the shift register unit comprises a plurality of flip-flops coupled in series, and
a flip-flop is allocated to a respective electrical fuse, the flip-flop capable of receiving information on the respective electrical fuse.

13. The semiconductor package system according to claim 11, wherein the shift register unit, in response to the clock signal, receives the input signal in series, and then generates the rupture information and outputs the rupture information in parallel.

14. The semiconductor package system according to claim 11, wherein one or more of the input signal, the clock signal, and the rupture enable signal are controlled by the JTAG circuit.

15. The semiconductor package system according to claim 10, wherein the semiconductor chip comprises:
a scan unit configured to output information on whether the each of the plurality of electrical fuses are ruptured or not, as scan information, when a scan enable signal is activated; and
a shift register unit configured to receive the scan information and output the scan information as an output signal in synchronization with a clock signal.

16. The semiconductor package system according to claim 15, wherein the shift register unit comprises a plurality of flip-flops coupled in series, and
a flip-flop is allocated to a respective electrical fuse, the flip-flop capable of receiving information on the respective electrical fuse.

17. The semiconductor package system according to claim 16, wherein in response to the clock signal, one or more of the flip-flops serially output the scan information received in parallel as the output signal.

18. The semiconductor package system according to claim 15, wherein one or more of the clock signal and the scan enable signal are controlled by the JTAG circuit, and the output signal is provided to the JTAG circuit.

19. The semiconductor package system according to claim 10, further comprising a package board having a JTAG input/output terminal,
wherein the control chip is capable of communicating with the JTAG input/output terminal.

20. The semiconductor package system according to claim 19, wherein the JTAG input/output terminal comprises TDI, TDO, TMS, TCK, or a TRST terminal.

21. The semiconductor package system according to claim 10, wherein the semiconductor chip comprises a plurality of memory cells, and
at least one of the plurality of electrical fuses comprises electrical fuses for repairing a memory cell.

22. The semiconductor package system according to claim 10, wherein the semiconductor chip is configured in a multi-chip type in which a plurality of chips are stacked and coupled through a plurality of TSVs, and
at least one of the electrical fuses comprises an electrical fuse for repairing a TSV.

23. The semiconductor apparatus according to claim 1, wherein the shift register unit receives a serial input signal or parallel input signal according to the clock signal, and stores the received signal as the rupture information.

24. The semiconductor apparatus according to claim 1, wherein the shift register unit comprises:
a plurality of multiplexers configured to select and output a parallel input signal or serial input signal in response to a parallel select signal; and
a plurality of flip-flops configured to receive an output of the multiplexer.

25. The semiconductor package system according to claim 11, wherein the shift register unit receives a serial input signal or parallel input signal according to the clock signal, and stores the received signal as the rupture information.

26. The semiconductor package system according to claim 11, wherein the shift register unit comprises:
a plurality of multiplexers configured to select and output a parallel input signal or serial input signal in response to a parallel select signal; and
a plurality of flip-flops configured to receive an output of the multiplexer.
